(19) United States
(12) Patent Application Publication
(10) Pub. No.: US 2005/0026795 A1
(43) Pub. Date: Feb. 3, 2005

(54) Polyester-containing composition, uses thereof

(75) Inventor: Vanina Filippi, Paris (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: L'OREAL, Paris (FR)

(21) Appl. No.: 10/893,260

(22) Filed: Jul. 19, 2004

Related U.S. Application Data
(60) Provisional application No. 60/490,941, filed on Jul. 30, 2003.

(30) Foreign Application Priority Data
Jul. 17, 2003 (FR) 0308730

(51) Int. Cl. C11D 1/00

(52) U.S. Cl. 510/130

(57) ABSTRACT

The present invention relates to a cosmetic composition, for caring for or making up keratin materials, containing a cosmetically acceptable medium containing i) at least one polyester resulting from the esterification, with a polycarboxylic acid, of an aliphatic hydroxycarboxylic acid ester, comprising at least two hydroxyl groups and ii) at least one hydrocarbon-based ester other than the polyester. This composition has gloss, tack-resistance, migration-resistance, comfort and staying-power properties, in particular in terms of staying power of the colour.

### REFERENCE TO PRIOR APPLICATIONS

This application claims priority to U.S. provisional application 60/490,941 filed Jul. 30, 2003, and to French patent application 0308730 filed Jul. 17, 2003, both incorporated herein by reference.

### FIELD OF THE INVENTION

The present invention relates to a composition, preferably a cosmetic composition for making up or caring for the skin, including the scalp, of either the human face or body, and human lips or integuments, for instance the hair, the eyelashes, the eyebrows or the nails, comprising a cosmetically acceptable medium containing a particular polyester. This composition has noteworthy cosmetic properties and in particular gives the makeup or care treatment tack-resistance, migration-resistance, gloss, staying-power and comfort properties.

More particularly, the present invention relates to a composition comprising a cosmetically acceptable medium containing i) at least one polyester resulting from the esterification, with a polycarboxylic acid, of an aliphatic hydroxycarboxylic acid ester, comprising at least two hydroxyl groups and ii) at least one hydrocarbon-based ester other than the polyester. This composition has gloss, tack-resistance, migration-resistance, comfort and staying-power properties, in particular in terms of staying power of the colour.

The composition of the invention may in particular constitute a makeup product for the human body, lips or integuments, in particular having care properties. It especially constitutes a lipstick or a lip gloss, a makeup rouge, an eyeshadow, a tattoo product, a mascara, an eyeliner, a nail varnish, or an artificial tanning product for the skin, a hair colouring product or a haircare product.

Additional advantages and other features of the present invention will be set forth in part in the description that follows and in part will become apparent to those having ordinary skill in the art upon examination of the following or may be learned from the practice of the present invention. The advantages of the present invention may be realized and obtained as particularly pointed out in the appended claims. As will be realized, the present invention is capable of other and different embodiments, and its several details are capable of modifications in various obvious respects, all without departing from the present invention. The drawings and description are to be regarded as illustrative in nature, and not as restrictive.

### DETAILED DESCRIPTION OF THE PREFERRED EMBODIMENTS

The inventor has found, surprisingly, that the use i) of at least one polyester resulting from the esterification, with a polycarboxylic acid, of an aliphatic hydroxycarboxylic acid ester, the ester comprising at least two hydroxyl groups, and ii) of at least one hydrocarbon-based ester other than the polyester, makes it possible to obtain a composition that is comfortable, tack-resistant, migration-resistant, glossy and/or that has good staying-power.

One subject of the invention is thus a cosmetic composition, especially for caring for or making up keratin materials, comprising a cosmetically acceptable medium containing i) at least one polyester resulting from the esterification, with a polycarboxylic acid, of an aliphatic hydroxycarboxylic acid ester, the ester comprising at least two hydroxyl groups and ii) at least one hydrocarbon-based ester other than the polyester advantageously in the form of an oil.

A subject of the invention is also a cosmetic process for giving a film of cosmetic composition staying-power, tack-resistance, migration-resistance, gloss and/or comfort properties, which consists in introducing into the composition i) at least one polyester resulting from the esterification, with a polycarboxylic acid, of an aliphatic hydroxycarboxylic acid ester, the ester comprising at least two hydroxyl groups and ii) at least one hydrocarbon-based ester other than the polyester advantageously in the form of an oil.

A subject of the invention is also the use of the combination i) of at least one polyester resulting from the esterification, with a polycarboxylic acid, of an aliphatic hydroxycarboxylic acid ester comprising at least two hydroxyl groups and ii) of at least one hydrocarbon-based ester other than the polyester, advantageously in the form of an oil, in a physiologically acceptable composition endowed with staying-power, tack-resistance, migration-resistance, gloss and/or comfort properties.

Finally, a subject of the invention is the use i) of at least one polyester resulting from the esterification, with a polycarboxylic acid, of an aliphatic hydroxycarboxylic acid ester comprising at least two hydroxyl groups and ii) of at least one hydrocarbon-based ester other than the polyester, advantageously in the form of an oil, in a physiologically acceptable composition, as an agent for giving the composition staying-power, tack-resistance, migration-resistance, gloss and/or comfort properties.

Polyester

The polyester according to the invention results from the esterification
of a polycarboxylic acid, and
of an aliphatic hydroxycarboxylic acid ester (which will be referred to hereinbelow as “hydroxylated ester”).
   Hydroxylated Ester

The aliphatic hydroxycarboxylic acid ester (or hydroxylated ester) comprises at least two hydroxyl groups.

The hydroxylated ester is advantageously derived from the reaction of at least one hydroxylated aliphatic carboxylic acid with a polyol.

The hydroxylated aliphatic acid preferably contains from 2 to 40 carbon atoms, more preferably from 10 to 34 carbon atoms and better still from 12 to 28 carbon atoms; it also comprises from 1 to 20 hydroxyl groups, preferably from 1 to 10 hydroxyl groups and better still from 1 to 6 hydroxyl groups, which may be subsequently esterified with the polycarboxylic acid to obtain the polyester of the present invention.

The polyol may preferably contain from 2 to 40 carbon atoms and better still from 3 to 30 carbon atoms. The polyol is preferably an aliphatic polyol. Advantageously, the polyol is not a saccharide.

The polyol that reacts with the hydroxylated acid described above may be partially or totally esterified; advantageously, the polyol is totally esterified.

Preferably, the aliphatic hydroxycarboxylic acid ester is a hydroxylated fatty acid ester such that the fatty acid residue contains at least 12 carbon atoms, for example from 12 to 40 carbon atoms and better still from 12 to 28 carbon atoms.

The aliphatic hydroxycarboxylic acid ester that may be used in the invention may preferably be chosen from:
a) partial or total esters of saturated linear monohydroxylated aliphatic monocarboxylic acids;
b) partial or total esters of unsaturated monohydroxylated aliphatic monocarboxylic acids such as glyceryl triricinoleate (castor oil);
c) partial or total esters of a C₂ to C₁₀ aliphatic polyol that has reacted with a monohydroxylated or polyhydroxylated aliphatic monocarboxylic or polycarboxylic acid especially such as triglycerides, esters of pentaerythritol, of trimethylolpropane, of propylene glycol, of neopentyl glycol, of dipentaerythritol or of polyglycerol, and sorbitol esters; and mixtures thereof.

Advantageously, when the aliphatic hydroxycarboxylic acid ester results from the esterification of an aliphatic polycarboxylic acid such as those mentioned above, no residue COOH groups not engaged in an ester bond remain.

The aliphatic hydroxycarboxylic acid ester is preferably chosen from esters of C₂ to C₁₆ aliphatic polyols, the polyols having reacted with a hydroxylated aliphatic fatty acid with a saturated or unsaturated chain, containing at least 12 carbon atoms. The fatty acid is preferably ricinoleic acid and the aliphatic hydroxycarboxylic acid ester is preferably hydrogenated castor oil.

Hydrogenated castor oil is commercially available. It is, for example, the product Himako P® from Hawaken Fine Chemicals.

Polycarboxylic Acid

The polycarboxylic acid comprises at least two COOH groups. It is advantageously a diacid dimer of unsaturated aliphatic carboxylic acid(s).

The polycarboxylic acid according to the invention is preferably aliphatic; it is advantageously an aliphatic dicarboxylic acid.

According to one embodiment, the polycarboxylic acid is a diacid dimer of unsaturated fatty acid(s), i.e. a dimer formed from at least one unsaturated fatty acid, for example from a single unsaturated fatty acid or from two different unsaturated fatty acids. The fatty acid is preferably monounsaturated or diunsaturated. The term “fatty acid” means an acid obtainable by hydrolysis of a fatty substance of plant or animal origin.

The diacid dimers of unsaturated fatty acid(s), or alternatively diacid dimers, are conventionally obtained by an intermolecular dimerization reaction of at least one unsaturated fatty acid. Preferably, only one type of unsaturated fatty acid is dimerized.

The diacid dimers of unsaturated fatty acid(s) are especially obtained by dimerization of an unsaturated fatty acid especially of C₈ to C₃₄, especially C₁₂ to C₂₂, in particular C₁₆ to C₂₀ and more particularly of C₁₈.

Representative unsaturated fatty acids that may especially be mentioned include undecenoic acid, linderic acid, myristoleic acid, palmitoleic acid, oleic acid, linoleic acid, elaidinic acid, gadolenoic acid, eicosapentaenoic acid, docosahexaenoic acid, erucic acid, brassidic acid and arachidonic acid, and mixtures thereof.

The diacid dimer is advantageously obtained by dimerization of linoleic and/or linolenic acid. The commercial product Pripol 1009® from Uniqema is used, for example.

The diacid dimer is preferably saturated, i.e. it contains no carbon-carbon double bonds, and it is obtained by condensation of unsaturated fatty acid(s) optionally followed by a hydrogenation, to convert any double bonds into single bonds.

The diacid dimers of unsaturated fatty acid(s) that are preferred are obtained by dimerization of linoleic acid, optionally followed by hydrogenation of the dimer thus obtained. The hydrogenated form may be partial or total and may especially correspond to the saturated form, which is more stable to oxidation.

Diacid dimers and especially dilinoleic diacids whose oxidation stability has been improved by hydrogenation of the double bonds remaining after the dimerization reaction are also commercially available.

In the present invention, any diacid dimer may be used.

The polyester according to the invention preferably has a molecular weight of between 2000 and 8000 g/mol and more preferably between 3000 and 7000 g/mol, measured according to the calibration method with polystyrene using gel permeation chromatography under the following conditions:

| | |
|---|---|
| Machine | TOSOH SC-8010 System |
| Column | Shodex KF-800D + KF-805L × 2 |
| Eluent | THF |
| Temperature | Isothermic 40° C. column |
| Flow rate | 1.0 ml/min |
| Concentration | About 0.2 weight/vol % |
| Amount injected | 100 μl |
| Solubility | Total dissolution |
| Detector | Differential refractometer |

For example, Risocast DL-L® has a number-average molecular mass of between 3500 and 4000 g/mol and Risocast DA-H® has a number-average molecular mass of between 6000 and 6500 g/mol. These products are sold by the Japanese company Kokyu Alcohol Kogyo.

The molar ratio between the polycarboxylic acid and the hydroxylated ester used to prepare the polyester according to the invention is preferably between 0.20 and 1 and preferentially between 0.20 and 0.40. For example, this ratio is equal to 0.75 for Risocast DA-H® and is equal to 0.5 for Risocast DA-L®.

Mention may be made in particular, as polyesters that may be used in the composition according to the invention, of:
the ester resulting from the esterification reaction of hydrogenated castor oil with dilinoleic acid in proportions of 2 to 1,
the ester resulting from the esterification reaction of hydrogenated castor oil with isostearic acid in proportions of 4 to 3.

The polyester may comprise a compound of formula (1), a compound of formula (2) or a mixture thereof:

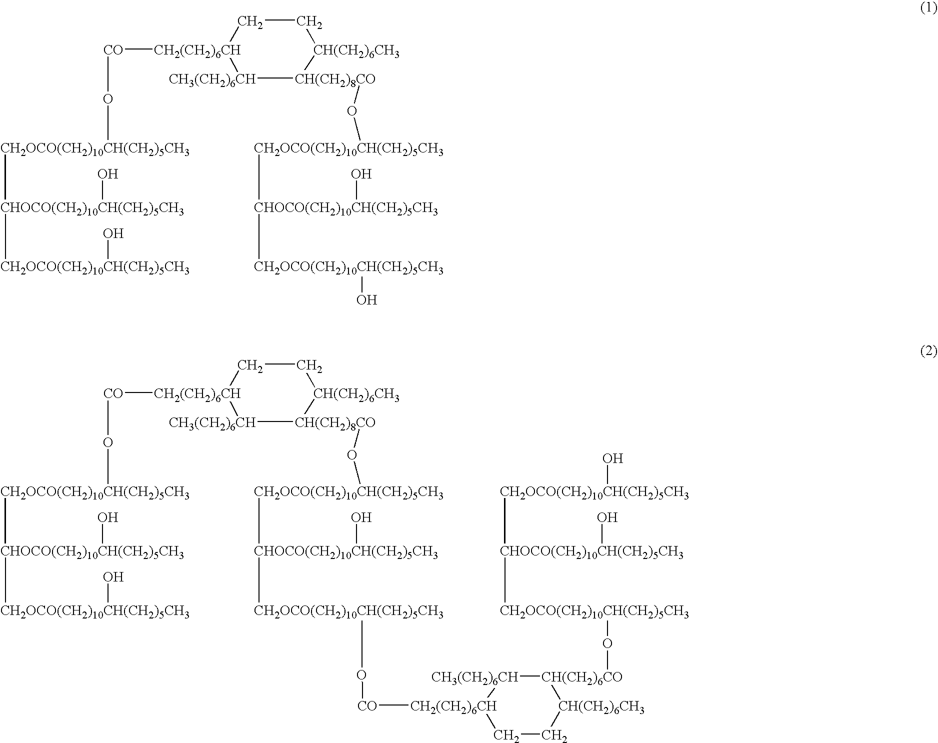

The polyester of the present invention is advantageously a compound that is pasty or viscous at room temperature (25° C.). For the purposes of the present invention, the term “pasty” denotes a lipophilic fatty compound, with a reversible solid/liquid change of state, and comprising at a temperature of 23° C. a liquid fraction and a solid fraction.

For the purposes of the present invention, the term “pasty compound” means a compound preferably having a hardness at 20° C. ranging from 0.001 to 0.5 MPa and preferably from 0.002 to 0.4 MPa.

By way of example, Risocast DA-L® has a hardness at 20° C. of 0.04 MPa, a liquid fraction at 23° C. equal to 82% and a liquid fraction at 32° C. equal to 90%.

The polyester of the composition according to the present invention may represent from 1% to 99%, preferably from 1% to 75% and better still from 5% to 60% of the total weight of the composition.

Hydrocarbon-Based Ester

The term “hydrocarbon-based ester” means a compound other than the polyester described above and comprising at least one COO ester function.

According to the invention, the word “ester” means a monoester, a diester, a triester and, more generally, a polyester other than the polyester described above.

The hydrocarbon-based ester in accordance with the invention is preferably an oil, i.e. a fatty substance that is liquid at atmospheric pressure and at a temperature of 23° C.

The hydrocarbon-based ester may be linear, branched or cyclic, and saturated or unsaturated.

The hydrocarbon-based ester is preferably a non-volatile oil.

The term “volatile oil” means an oil (or non-aqueous medium) capable of evaporating on contact with the skin in less than one hour, at room temperature and atmospheric pressure. The volatile oil is a volatile cosmetic oil, which is liquid at room temperature, especially having a non-zero vapour pressure, at room temperature and atmospheric pressure, in particular having a vapour pressure ranging from 0.13 Pa to 40 000 Pa (10⁻³ to 300 mm Hg) and preferably ranging from 1.3 Pa to 13 000 Pa (0.01 to 100 mm Hg) and preferentially ranging from 1.3 Pa to 1300 Pa (0.01 to 10 mm Hg).

In particular, the hydrocarbon-based ester may correspond to the formula RCOOR′ in which RCOO represents a carboxylic acid residue containing from 2 to 30 carbon atoms and R′ represents a hydrocarbon-based chain containing from 1 to 30 carbon atoms.

RCOO is preferably an aliphatic carboxylic acid residue containing from 2 to 30 carbon atoms, preferably from 4 to 26 carbon atoms and more preferably from 4 to 22 carbon atoms.

The radical R is advantageously an alkyl radical or an alkenyl radical. The term “alkyl radical” means a linear or branched, saturated aliphatic radical consisting of carbon and hydrogen. The term “alkenyl radical” means a linear or branched, aliphatic radical consisting of carbon and hydrogen, and unsaturated, i.e. comprising at least one carbon-carbon double bond, preferably from one to three double bonds and preferentially one carbon-carbon double bond.

RCOO may represent a fatty acid residue, i.e. an acid obtained by hydrolysis of a fatty substance of plant or animal origin.

The radical R′O represents an alcohol residue, preferably a linear or branched, saturated or unsaturated aliphatic alcohol. The radical R′ is advantageously an alkyl radical or an alkenyl radical, independently of the choice of the radical R, alkyl and alkenyl being defined as above.

R′O may represent a fatty alcohol residue, i.e. an alcohol obtained by hydrogenation of a fatty acid as defined above.

R′O is preferably an aliphatic alcohol residue containing 2 to 30 carbon atoms, preferably from 4 to 26 carbon atoms and more preferably from 4 to 22 carbon atoms.

R and R′ are chosen independently of each other. Preferably, they are chosen such that they are both saturated and branched, or both linear and monounsaturated.

The ester may especially comprise up to 60 carbon atoms, preferably from 10 to 45 and preferentially from 18 to 40 carbon atoms.

According to one embodiment, the hydrocarbon-based ester is a saturated, branched monoester. Preferably, the ester is a monoester of a saturated, branched aliphatic carboxylic acid and of a saturated, branched aliphatic alcohol.

According to another embodiment, the hydrocarbon-based ester is a monoester of an unsaturated linear fatty monoacid and of an unsaturated linear fatty monoalcohol (comprising a carbon-carbon double bond).

Thus, the esters may be chosen from a non-limiting list comprising neopentanoic acid esters, for instance isodecyl neopentanoate, isotridecyl neopentanoate, isostearyl neopentanoate and 2-octyldodecyl neopentanoate, isononanoic acid esters, for instance isononyl isononanoate, octyl isononanoate, isodecyl isononanoate, isotridecyl isononanoate and isostearyl isononanoate, but also isopropyl alcohol esters, such as isopropyl myristate, isopropyl palmitate, isopropyl stearate or isostearate, cetyl octanoate, tridecyl octanoate, 2-ethylhexyl 4-diheptanoate and palmitate, alkyl benzoate, polyethylene glycol diheptanoate and propylene glycol diethyl 2-hexanoate, and mixtures thereof. The ester may also be chosen from synthetic esters, especially of a fatty acid, for instance purcellin oil, isopropyl myristate, ethyl palmitate or octyl stearate; hydroxylated esters, for instance isostearyl lactate, octyl hydroxystearate, diisopropyl adipate, and fatty alcohol heptanoates, octanoates and decanoates, and mixtures thereof.

Isononyl isononanoate, oleyl erucate and 2-octyldodecyl neopentanoate and mixtures thereof are most particularly suitable for implementing the invention.

This or these hydrocarbon-based ester(s) may be used in the composition in a proportion of from 5% to 90%, especially from 10% to 60% and in particular from 20% to 50% by weight relative to the total weight of the composition.

Gloss of the Composition

In general, the cosmetic compositions and more particularly those intended to be applied to the lips may be characterized by a mean gloss index.

The term “mean gloss” means the gloss that may be measured using a conventional glossmeter, by the following method:

A coat 50 μm thick of the composition whose mean gloss it is desired to evaluate is spread onto a Leneta® brand contrast card of reference Form 1A Penopac, using an automatic spreader. The coat covers at least the white background of the card. The gloss at 20° is then measured on the white background using a Byk Gardner® glossmeter of reference microTri-Gloss.

The mean gloss of the composition is advantageously greater than or equal to 30, or even greater than or equal to 40, especially greater than or equal to 50, in particular greater than or equal to 60, more particularly greater than or equal to 65 or better still greater than or equal to 70, especially when the composition is intended to be applied to the lips.

For example, a cosmetic composition of lipstick type may have a mean gloss equal to about 60, a cosmetic composition of liquid gloss base type or a cosmetic composition of eyeshadow type may have a mean gloss equal to about 70, and a cosmetic composition of nail varnish base type may have a mean gloss equal to about 50.

Glossy Oil

The composition according to the invention advantageously contains an oil of high molar mass ranging from 650 to 10 000 g/mol, other than the polyester when it is in the form of an oil, and of the hydrocarbon-based ester described above. The term “oil” means a non-aqueous, water-immiscible compound that is liquid at room temperature (25° C.) and atmospheric pressure (760 mm Hg).

The oil used in the composition according to the present invention has a molar mass ranging from 650 to 10 000 g/mol and preferably between 750 and 7500 g/mol.

Specifically, oils with an excessively low molar mass, combined with the polyester in the composition according to the invention, produce compositions that are not glossy enough; oils with an excessively high molar mass give compositions that are considered too tacky.

Thus capric/caprylic acid triglyceride (such as the product sold or manufactured under the reference Estol 3603 MCT Oil by the company Uniqema), which has a molar mass equal to 494 g/mol, produces compositions whose cosmetic properties are not as good as those of oils with a molar mass ranging from 650 to 10 000 g/mol.

The oil with a molar mass ranging from 650 to 10 000 g/mol that may be used in the present invention may be chosen from:
lipophilic polymers such as:
   polybutylenes such as Indopol H-100 (molar mass or MM=965 g/mol), Indopol H-300 (MM=1340 g/mol) and Indopol H-1500 (MM=2160 g/mol), sold or manufactured by the company Amoco,
   hydrogenated polyisobutylenes such as Panalane H-300 E sold or manufactured by the company Amoco (M=1340 g/mol), Viseal 20000 sold or manufactured by the company Synteal (MM=6000 g/mol) and Rewopal PIB 1000 sold or manufactured by the company Witco (MM=1000 g/mol),
   polydecenes and hydrogenated polydecenes such as: Puresyn 10 (MM=723 g/mol) and Puresyn 150 (MM=9200 g/mol), sold or manufactured by the company Mobil Chemicals,
   vinylpyrrolidone copolymers such as: the vinylpyrrolidone/1-hexandecene copolymer Antaron V-216 sold or manufactured by the company ISP (MM=7300 g/mol),
esters such as:
   linear fatty acid esters with a total carbon number ranging from 35 to 70, for instance pentaerythrityl tetrapelargonate (MM=697.05 g/mol),
   hydroxylated esters such as polyglyceryl-2 triisostearate (MM=965.58 g/mol),
   aromatic esters such as tridecyl trimellitate (MM=7575.19 g/mol),
   esters of branched C₂₄-C₂₈ fatty alcohol or fatty acids, such as those described in patent application EP-A-0 955 039, and in particular triisoarachidyl citrate (MM=1033.76 g/mol), pentaerythrityl tetraisononanoate (MM=697.05 g/mol), glyceryl triisostearate (MM=891.51 g/mol), glyceryl tris(2-decyl)tetradecanoate (MM=1143.98 g/mol), pentaerythrityl tetraisostearate (MM=1202.02 g/mol), polyglyceryl-2 tetraisostearate (MM=1232.04 g/mol) or pentaerythrityl tetrakis(2-decyl)-tetradecanoate (MM=1538.66 g/mol),
silicone oils such as phenylsilicones, for instance Belsil PDM 1000 from the company Wacker (MM=9000 g/mol),
oils of plant origin such as sesame oil (820.6 g/mol),
and mixtures thereof.

The oil with a molar mass ranging from 650 to 10 000 g/mol used in the composition according to the invention may represent from 1% to 99%, preferably from 10% to 80% and better still from 5% to 70% of the total weight of the composition.

Pasty Compound

The composition may also contain a pasty compound other than the polyester described above.

For the purposes of the present invention, the term “pasty” is intended to denote a lipophilic fatty compound which undergoes a reversible solid/liquid change of state, having in the solid state an anisotropic crystal organization, and comprising at a temperature of 23° C. a liquid fraction and a solid fraction.

For the purposes of the invention, the term “pasty compound” means a compound having a hardness at 20° C. ranging from 0.001 to 0.5 MPa and preferably from 0.002 to 0.4 MPa.

The hardness is measured according to a method of penetration of a probe in a sample of compound and in particular using a texture analyzer (for example the TA-XT2i® machine from Rheo) equipped with a stainless-steel cylinder 2 mm in diameter. The hardness measurement is performed at 20° C. at the centre of five samples. The cylinder is introduced into each sample at a pre-speed of 1 mm/s and then at a measuring speed of 0.1 mm/s, the penetration depth being 0.3 mm. The hardness value revealed is that of the maximum peak.

This pasty compound is also, at a temperature of 23° C., in the form of a liquid fraction and a solid fraction. In other words, the starting melting point of the pasty compound is less than 23° C. The liquid fraction of the pasty compound measured at 23° C. represents 9% to 97% by weight of the compound. This liquid fraction at 23° C. preferably represents between 15% and 85% and more preferably between 40% and 85% by weight.

The liquid fraction by weight of the pasty compound at 23° C. is equal to the ratio of the heat of fusion consumed at 23° C. to the heat of fusion of the pasty compound.

The heat of fusion of the pasty compound is the heat consumed by the compound to change from the solid state to the liquid state. The pasty compound is said to be in the solid state when all of its mass is in solid crystalline form. The pasty compound is said to be in the liquid state when all of its mass is in liquid form.

The heat of fusion of the pasty compound is equal to the area under the curve of the thermogram obtained using a differential scanning calorimeter (DSC), such as the calorimeter sold under the name MDSC 2920® by the company TA Instrument, with a temperature rise of 5 or 10° C. per minute, according to standard ISO 11357-3:1999. The heat of fusion of the pasty compound is the amount of energy required to make the compound change from the solid state to the liquid state. It is expressed in J/g.

The heat of fusion consumed at 23° C. is the amount of energy absorbed by the sample to change from the solid state to the state that it has at 23° C., consisting of a liquid fraction and a solid fraction.

The liquid fraction of the pasty compound, measured at 32° C., preferably represents from 30% to 100% by weight of the compound, preferably from 80% to 100% and more preferably from 90% to 100% by weight of the compound. When the liquid fraction of the pasty compound measured at 32° C. is equal to 100%, the temperature of the end of the melting range of the pasty compound is less than or equal to 32° C.

The liquid fraction of the pasty compound measured at 32° C. is equal to the ratio of the heat of fusion consumed at 32° C. to the heat of fusion of the pasty compound. The heat of fusion consumed at 32° C. is calculated in the same marner as the heat of fusion consumed at 23° C.

The pasty compound is preferably chosen from synthetic compounds and compounds of plant origin. A pasty compound may be obtained by synthesis from starting materials of plant origin.

The pasty compound is advantageously chosen from:
lanolin and its derivatives,
polymer or non-polymer fluoro compounds,
polymer or non-polymer silicone compounds,
vinyl polymers, especially:
   olefin homopolymers
   olefin copolymers
   hydrogenated diene homopolymers and copolymers
   linear or branched oligomers, which are homopolymers or copolymers of alkyl (meth)acrylates preferably containing a C₈-C₃₀ alkyl group
   oligomers, which are homopolymers and copolymers of vinyl esters containing C₈-C₃₀ alkyl groups
   oligomers, which are homopolymers and copolymers of vinyl ethers containing C₈-C₃₀ alkyl groups,
   liposoluble polyethers resulting from the polyetherification between one or more C₂-C₁₀₀ and preferably C₂-C₅₀ diols,
   esters,
      and mixtures thereof.

The pasty compound is preferably a polymer and especially a hydrocarbon-based polymer.

The pasty compound is preferably free of lanolin or derivatives thereof. A preferred silicone and fluoro pasty compound is polymethyl trifluoropropyl methylalkyl dimethylsiloxane, sold under the name X22-1088′ by Shin-Etsu.

Among the liposoluble polyethers that are particularly preferred are copolymers of ethylene oxide and/or of propylene oxide with C₆-C₃₀ long-chain alkylene oxides, more preferably such that the weight ratio of the ethylene oxide and/or of the propylene oxide to the alkylene oxides in the copolymer is from 5:95 to 70:30. In this family, mention will be made especially of copolymers such that the long-chain alkylene oxides are arranged in blocks with an average molecular weight of from 1 000 to 10 000, for example a polyoxyethylene/polydodecyl glycol block copolymer such as the ethers of dodecanediol (22 mol) and of polyethylene glycol (45 EO) sold under the brand name Elfacos ST9® by Akzo Nobel.

Among the pasty esters that are especially preferred are:
esters of a glycerol oligomer, especially diglycerol esters, in particular condensates of adipic acid and of glycerol, for which some of the hydroxyl groups of the glycerols have reacted with a mixture of fatty acids such as stearic acid, capric acid, stearic acid and isostearic acid and 12-hydroxystearic acid, for instance those sold under the brand name Softisan 649® by the company Sasol,
arachidyl propionate sold under the brand name Waxenol 801® by Akzo,
phytosterol esters,
non-crosslinked polyesters resulting from polycondensation between a linear or branched C₄-C₅₀ dicarboxylic acid or polycarboxylic acid and a C₂-C₅₀ diol or polyol, other than the polyester described above,
aliphatic esters of an ester resulting from the esterification of an aliphatic hydroxycarboxylic acid ester with an aliphatic monocarboxylic acid; and mixtures thereof, for instance
   the ester resulting from the esterification reaction of hydrogenated castor oil with isostearic acid in proportions of 1 to 1 (1/1) or hydrogenated castor oil monoisostearate,
   the ester resulting from the esterification reaction of hydrogenated castor oil with isostearic acid in proportions of 1 to 2 (1/2) or hydrogenated castor oil diisostearate,
   the ester resulting from the esterification reaction of hydrogenated castor oil with isostearic acid in proportions of 1 to 3 (1/3) or hydrogenated castor oil triisostearate,
   and mixtures thereof.

Among the pasty compounds of plant origin that which will preferably be chosen is an oxyethylenated (5 EO) oxypropylenated (5 PO) mixture of soybean sterols and of pentaerythritol, sold under the reference Lanolide® by the company Vevy.

The pasty compound preferably represents 1% to 99%, better still 1% to 60%, better still 2% to 30% and even better still 5% to 15% by weight of the composition.

Dye

Advantageously, the composition of the invention may also comprise at least one dyestuff, which may be chosen from dyes that are soluble or dispersible in the composition, pigments and nacres, and mixtures thereof. The dyes are preferably liposoluble dyes, although water-soluble dyes may be used. This dyestuff may represent from 0.001% to 98%, preferably from 0.5% to 85% and better still from 1% to 60% of the total weight of the composition.

For a composition in the form of a paste or a cast product such as lipsticks or body makeup products, from 0.5% to 50%, preferably from 2% to 40% and better still from 5% to 30% of dyestuff, relative to the total amount of the composition, is generally used.

The liposoluble dyes are, for example, Sudan Red, D & C Red 17, D & C Green 6, β-carotene, soybean oil, Sudan Brown, D & C Yellow 11, D & C Violet 2, D & C Orange 5, quinoline yellow and annatto. They may represent from 0 to 20% and better still from 0.1% to 6% of the weight of the composition. The water-soluble dyes are especially beetroot juice or methylene blue, and may represent from 0.1% to 6% by weight of the composition (if present).

Preferably, the composition of the invention comprises a particulate phase, which is advantageously coloured, which may represent from 0.001% to 50%, preferably from 0.01% to 40% and better still from 0.05% to 30% of the total weight of the composition, and which may comprise pigments and/or nacres and/or fillers usually in cosmetic compositions.

The term “pigments” should be understood as meaning white or coloured, mineral or organic particles, which are insoluble in the liquid fatty phase, and which are intended to colour and/or opacify the composition. The term “fillers” should be understood as meaning colourless or white, mineral or synthetic, lamellar or non-lamellar particles. The term “nacres” should be understood as meaning iridescent particles, produced especially by certain molluscs in their shell or alternatively synthesized. These fillers and nacres serve especially to modify the texture of the composition.

The pigments may be present in the composition in a proportion of from 0.05% to 30% (if present) and preferably in a proportion of from 2% to 20% of the weight of the final composition. As mineral pigments that may be used in the invention, mention may be made of titanium oxide, zirconium oxide or cerium oxide, and also zinc oxide, iron oxide or chromium oxide and ferric blue. Among the organic pigments that may be used in the invention, mention may be made of carbon black and barium, strontium, calcium (D & C Red No. 7) and aluminium lakes.

The nacres may be present in the composition in a proportion of from 0.001% to 20% and preferably in a proportion of about from 1% to 15% (if present) of the total weight of the composition. Among the nacres that may be used in the invention, mention may be made of mica coated with titanium oxide, with iron oxide, with natural pigment or with bismuth oxychloride, such as coloured titanium mica.

The composition advantageously contains goniochromatic pigments, for example multilayer interference pigments, and/or reflective pigments. These two types of pigment are described in patent application FR 0 209 246, the content of which is incorporated by reference into the present patent application.

Fillers

The fillers may be present in a proportion of from 0.001% to 35% and preferably 0.5% to 15% (if present) of the total weight of the composition. Mention may be made especially of talc, mica, kaolin, Nylon® (especially Organsol) powder and polyethylene powder, polytetrafluoroethylene (Teflon®) powders, starch, boron nitride, copolymer microspheres such as Expancel® (Nobel Industrie), Polytrap® (Dow Corning), Polypore® L 200 (Chemdal Corporation), silicone resin microbeads (for example Tospearl® from Toshiba) and silica.

Wax

In particular, the composition also contains at least one wax. For the purposes of the present invention, the term “wax” means a lipophilic fatty compound that is solid at room temperature (25° C.), which undergoes a reversible solid/liquid change of state, which has a melting point of greater than 30° C. which may be up to 200° C. and a hardness of greater than 0.5 MPa, and which has an anisotropic crystal organization in the solid state. By bringing the wax to its melting point, it is possible to make it miscible with oils and to form a microscopically homogeneous mixture, but on returning the temperature of the mixture to room temperature, recrystallization of the wax in the oils of the mixture is obtained.

The waxes that may be used in the invention are compounds that are solid at room temperature, intended to structure the composition, in particular in the form of a stick; they may be hydrocarbon-based waxes, fluoro waxes and/or silicone waxes and may be of plant, mineral, animal and/or synthetic origin. In particular, they have a melting point of greater than 40° C. and better still greater than 45° C.

As waxes that may be used in the invention, mention may be made of those generally used in cosmetics: they are especially of natural origin, for instance beeswax, carnauba wax, candelilla wax, ouricoury wax, Japan wax, cork fibre wax, sugarcane wax, rice wax, montan wax, paraffin, lignite wax or microcrystalline wax, ceresin, ozokerite and hydrogenated oils, for instance jojoba oil; synthetic waxes, for instance the polyethylene waxes derived from the polymerization or copolymerization of ethylene and Fischer-Tropsch waxes, or alternatively fatty acid esters, for instance octacosanyl stearate, glycerides that are solid at 40° C. and better still at 45° C., silicone waxes, for instance alkyl- or alkoxydimethicones containing an alkyl or alkoxy chain of 10 to 45 carbon atoms, poly(di)methylsiloxane esters that are solid at 40° C. and whose ester chain contains at least 10 carbon atoms; and mixtures thereof.

The composition according to the invention advantageously contains polyethylene wax with a weight-average molecular mass of between 300 and 700 and especially equal to 500 g/mol.

As a guide, the wax may represent from 0.01% to 50%, preferably from 2% to 40% and better still from 5% to 30% of the total weight of the composition.

Non-Glossy Oils

The additional oils other than the oils with a molar mass ranging from 650 to 10 000 g/mol and other than the hydrocarbon-based ester according to the invention may be hydrocarbon-based oils and/or silicone oils and/or fluoro oils. These oils may be of animal, plant, mineral or synthetic origin. The term “hydrocarbon-based oil” means an oil mainly comprising carbon and hydrogen atoms and possibly one or more functions chosen from hydroxyl, ester, ether and carboxylic functions. As examples of additional oils that may be used in the invention, mention may be made of:
hydrocarbon-based oils of animal origin such as perhydrosqualene;
hydrocarbon-based plant oils such as liquid triglycerides of fatty acids containing from 4 to 10 carbon atoms, for instance heptanoic or octanoic acid triglycerides, orjojoba oil;
linear or branched hydrocarbons of mineral or synthetic origin, such as liquid paraffins and derivatives thereof, and petroleum jelly;
fatty alcohols containing from 12 to 26 carbon atoms, for instance octyldodecanol, 2-butyloctanol, 2-hexyldecanol, 2-undecylpentadecanol and oleyl alcohol;
fluoro oils that are optionally partially hydrocarbon-based and/or silicone based;
silicone oils, for instance volatile or non-volatile, linear or cyclic polydimethylsiloxanes (PDMSs); polydimethylsiloxanes comprising alkyl, alkoxy or phenyl groups, which are pendant or at the end of a silicone chain, these groups containing from 2 to 24 carbon atoms; phenylsilicones, for instance phenyl trimethicones (such as the phenyl trimethicone sold under the trade name DC556 by Dow Corning), phenyl dimethicones, phenyltrimethylsiloxydiphenylsiloxanes, diphenyl dimethicones, diphenylmethyldiphenyltrisiloxanes and 2-phenylethyl trimethylsiloxysilicates;
fatty acids containing from 12 to 26 carbon atoms, for instance oleic acid; and mixtures thereof.

Additional oils of plant or synthetic origin are preferably used.

The additional oils may represent from 0.001% to 90%, preferably from 0.05% to 60% and better still from 1% to 35% of the total weight of the composition.

Additives

The composition of the invention may also comprise any additional additive usually used in the field under consideration, such as water, antioxidants, preserving agents, neutralizers, lipophilic gelling agents or liquid non-aqueous compounds, dispersants and cosmetic active agents. These additives may be present in the composition in a proportion of from 0.0005% to 20% and better still from 0.001% to 10% relative to the total weight of the composition, with the exception of water, which may represent from 0% to 70% and for example from 1% to 50%, and better still from 1% to 10% relative to the total weight of the composition.

As cosmetic active agents that may be used in the invention, mention may be made of vitamins A, E, C, B₃ and F, provitamins, for instance D-panthenol, glycerol, calmative active agents, for instance α-bisabolol, aloe vera, allantoin, plant extracts or essential oils, protecting agents or restructuring agents, for instance ceramides, “refreshing” active agents, for instance menthol and its derivatives, emollients (cocoa butter, dimethicone), moisturizers (arginine PCA), anti-wrinkle active agents, essential fatty acids and sunscreens, and mixtures thereof.

Needless to say, a person skilled in the art will take care to select the optional additional additives and/or the amount thereof such that the advantageous properties of the composition according to the invention are not, or are not substantially, adversely affected by the envisaged addition.

Galenical Forms

The compositions according to the invention have numerous applications and concern all coloured or uncoloured cosmetic products and more particularly lipsticks.

The composition of the invention may be in any form, for example a form of a composition that is solid, compacted or cast especially in stick or dish form, pasty or liquid. It is advantageously in solid form, i.e. in hard form (which does not flow under its own weight) especially cast or compacted, for example in stick or dish form.

It may be in the form of a paste, a solid or a cream. It may be an oil-in-water or water-in-oil emulsion, a solid or soft anhydrous gel, or alternatively in the form of a free or compacted powder and even in two-phase form. It is preferably in the form of a composition with an oily and especially anhydrous continuous phase; in this case, it may contain an aqueous phase in a content of less than 5%.

The composition according to the invention may be in the form of a coloured or uncoloured skincare composition, in the form of an antisun or makeup-removing composition or alternatively in the form of a hygiene composition. If it contains cosmetic active agents, it may then be used as a care base or a non-therapeutic treatment base for the skin such as the hands or the face or for the lips (lip balms, for protecting the lips from cold and/or sunlight and/or wind) or an artificial tanning product for the skin.

The composition of the invention may also be in the form of a coloured makeup product for the skin, in particular for the face, for instance a blusher, a foundation, a makeup rouge or an eye-shadow, a makeup product for the body, for instance a semi-permanent tattoo product, or a makeup product for the lips, for instance a lipstick or a lip gloss, optionally having care properties or non-therapeutic treatment properties, a makeup product for the integuments, for instance a nail varnish, a mascara or an eyeliner, or a hair dye product or haircare product.

Preferably, the composition according to the invention is in the form of a lipstick or a lip gloss.

Needless to say, the composition of the invention should be physiologically acceptable (in particular cosmetically acceptable), i.e. non-toxic and able to be applied to human skin, integuments or lips.

The term “cosmetically acceptable” means having a pleasant taste, feel, appearance and/or odour, applicable several days for several months.

The composition according to the invention may be manufactured by the known processes generally used in cosmetics.

The examples that follow are intended to illustrate the object of the present invention in a non-limiting manner. The amounts are given as percentages by weight.

### EXAMPLE 1 AND COMPARATIVE EXAMPLE 2

### Lipstick in Stick Form

In Comparative Example 2, Risocast DA-L was replaced weight for weight with oxypropylenated lanoline wax (sold under the reference Emery 1695 by the company Cognis).

| | | Test 1 | Test 2 |
|---|---|---|---|
| | | Test of the | Comparative |
| Phase | Starting materials | invention | test |
| A- | Oleyl erucate | 9 | 9 |
| | Isononyl isononanoate | 17.7 | 17.7 |
| | Isostearic, adipic and glyceryl plant | 10.6 | 10.6 |
| | fatty acid esters (Softisan ® 649) | | |
| | BHT | 0.06 | 0.06 |
| B- | Isononyl isononanoate | 4.16 | 4.16 |
| | Oleyl erucate | 4.16 | 4.16 |
| | Polyvinyl laurate | 8 | 8 |
| | Oxypropylenated lanolin wax | — | 9.01 |
| | Polyester of dilinoleic acid dimer and | 9.01 | — |
| | of hydrogenated castor oil (Risocast | | |
| | DA-L ® from the company Kokyu | | |
| | Alcohol Kogyo) | | |
| | Isostearic, adipic and glyceryl plant | 3.44 | 3.44 |
| | fatty acid esters (Softisan ® 649) | | |
| | Trioleyl phosphate | 1 | 1 |
| | Glycerol | 7.97 | 7.97 |
| | Hectorite modified with | 1.17 | 1.17 |
| | distearyldimethylammonium chloride | | |
| | BHT | 0.06 | 0.06 |
| C- | Polyethylene wax (MW 500) | 7 | 7 |
| | Carnauba wax | 2.4 | 2.4 |
| D- | Hydrophobic fumed silica | 1 | 1 |
| | Pigments | 8.7 | 8.7 |
| E- | Active agents | 4.06 | 4.06 |
| F- | Fragrance | 0.5 | 0.5 |

Procedure
Grind phase D into the oily phase A with a three-roll mill.
Prepare the modified bectorite gel, using a high-pressure homogenizer, with all the compounds of phase B except for the glycerol.
Add the ground pigments, the bentone gel and the waxes (phase C) to a melting pot. Heat to 100° C. and homogenize using a Rayneri mixer (stirring speed: 1500 rpm).
Add the glycerol and increase the stirring speed to 3200 rpm. Stir for 10 minutes then reduce the stirring speed to 1500 rpm.
Add the active agents and the fragrance 5 minutes before casting.
Cast into a mould at 42° C., which is placed in a freezer at −20° C. for half an hour before stripping the sticks from the mould.
   Cosmetic Evaluation

The formulations were evaluated in a makeup room by 12 women according to different sensory criteria.

Example 1 is glossier on application and at one hour, develops the colour more substantially, and gives less of a greasy feel than Comparative Example 2.

An instrumental evaluation was also performed on 6 women.

Instrumental parameters

| | Comparative | |
|---|---|---|
| Formulations | Example 2 | Example 1 |
| Staying power of the colour at 1 | 88.0 | 90.0 |
| hour (%) | | |
| Staying power of the colour after | 44.0 | 53.0 |
| trials (%) | | |

Example 1 has better staying power of the colour after trials than Comparative Example 2 containing oxypropylenated lanolin wax.

### EXAMPLE 3 AND COMPARATIVE EXAMPLE 4

### Lipstick in Stick Form

In Comparative Example 4, the Risocast DA-L was replaced with acetylated lanolin (sold under the reference Acetadeps P80 by the company Croda).

| | | | Comparative |
|---|---|---|---|
| Phase | Starting materials | Example 3 | Example 4 |
| A- | Isostearic, adipic and glyceryl plant | 14.98 | 14.98 |
| | fatty acid esters (Softisan ® 649) | | |
| | Polyester of dilinoleic acid dimer and | 10.21 | — |
| | of hydrogenated castor oil (Risocast | | |
| | DA-L ® from the company Kokyu | | |
| | Alcohol Kogyo) | | |
| | Acetylated lanolin | — | 10.21 |
| | 2-Octyldodecyl neopentanoate | 19.06 | 19.06 |
| | Hydrogenated isoparaffin | 6.6 | 6.6 |
| | Caprylic/capric acid triglycerides | 10.21 | 21.21 |
| | Phenyltrimethylsiloxytrisiloxane | 6.94 | 6.94 |
| | (viscosity 20 cSt) | | |
| | BHT | 0.07 | 0.07 |
| | Polybutylene | 15.25 | 15.25 |
| B- | Polyethylene wax (MW 500) | 7.52 | 7.52 |
| | Microcrystalline wax | 2.6 | 2.6 |
| C- | Pigments | 4.44 | 4.44 |
| D- | Ethylene glycol dimethacrylate/lauryl | 0.92 | 0.92 |
| | methacrylate copolymer | | |
| E- | Active phase | 1.2 | 1.2 |

Procedure:
Grind phase C into the oily phase A.
Add the ground material, the waxes (phase B) and phase D to a melting pot.
Heat to 100° C. and homogenize using a Rayneri mixer.
5 minutes before casting, add the active phase E.
Cast in a mould at 42° C., and place in a refrigerator at −20° C. for half an hour before stripping the sticks from the mould.
   Cosmetic Evaluation:

The formulations were evaluated in a makeup room by 12 women according to different criteria.

The stick of Example 3 is less tacky on application and after one hour, and migrates less.

The above written description of the invention provides a manner and process of making and using it such that any person skilled in this art is enabled to make and use the same, this enablement being provided in particular for the subject matter of the appended claims and including a cosmetic composition, comprising a cosmetically acceptable medium comprising i) at least one polyester resulting from the esterification, with a polycarboxylic acid, of an aliphatic hydroxycarboxylic acid ester, the ester comprising at least two hydroxyl groups and ii) at least one hydrocarbon-based ester other than the polyester.

All references, patents, applications, tests, standards, documents, publications, brochures, texts, articles, etc. mentioned herein are incorporated herein by reference. Where a numerical limit or range is stated, all values and subranges therewithin are specifically included as if explicitly written out.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

1. A cosmetic composition, comprising a cosmetically acceptable medium comprising i) at least one polyester resulting from the esterification, with a polycarboxylic acid, of an aliphatic hydroxycarboxylic acid ester, the ester comprising at least two hydroxyl groups and ii) at least one hydrocarbon-based ester other than the polyester.

2. The composition according to claim 1, wherein the polycarboxylic acid is an aliphatic polycarboxylic acid.

3. The composition according to claim 1, wherein the polycarboxylic acid is a diacid dimer formed from at least one unsaturated fatty acid.

4. The composition according to claim 3, wherein the dimer is an unsaturated C₈ to C₃₄ fatty acid dimer.

5. The composition according to claim 4, wherein the unsaturated fatty acid(s) is(are) selected from the group consisting of undecenoic acid, linderic acid, myristoleic acid, palmitoleic acid, oleic acid, linoleic acid, elaidinic acid, gadolenoic acid, eicosapentaenoic acid, docosahexaenoic acid, erucic acid, brassidic acid and arachidonic acid, and mixtures thereof.

6. The composition according to claim 5, wherein the unsaturated fatty acid is linoleic acid and the dimer is dilinoleic acid.

7. The composition according to claim 3, wherein the diacid dimer is saturated, i.e. it contains no carbon-carbon double bonds, and it is obtained by condensation of unsaturated fatty acid(s) optionally followed by a hydrogenation, to convert any double bonds into single bonds.

8. The composition according to claim 1, wherein the aliphatic hydroxycarboxylic acid ester is selected from the group consisting of:
a) partial or total esters of saturated linear monohydroxylated aliphatic monocarboxylic acids;
b) partial or total esters of unsaturated monohydroxylated aliphatic monocarboxylic acids;
c) partial or total esters of a C₂ to C₁₆ aliphatic polyol that has reacted with a monohydroxylated or polyhydroxylated aliphatic monocarboxylic or polycarboxylic acid;
and mixtures thereof.

9. The composition according to claim 1, wherein the aliphatic hydroxycarboxylic acid ester is at least one selected from the group consisting of esters of C₂ to C₁₆ aliphatic polyols, the polyols having reacted with a hydroxylated aliphatic fatty acid with a saturated or unsaturated chain, containing at least 12 carbon atoms.

10. The composition according to claim 1, wherein the aliphatic hydroxycarboxylic acid ester is at least one selected from the group consisting of saturated or unsaturated esters of C₂ to C₁₆ aliphatic polyols, the polyols having reacted with ricinoleic acid.

11. The composition according to claim 1, wherein the aliphatic hydroxycarboxylic acid ester is hydrogenated castor oil.

12. The composition according to claim 1, wherein the polyester has a liquid fraction and a solid fraction at 23° C. and a hardness ranging from 0.001 to 0.5 MPa.

13. The composition according to claim 1, wherein the polyester represents from 1% to 99% of the total weight of the composition.

14. The composition according to claim 1, wherein the hydrocarbon-based ester is an oil.

15. The composition according to claim 1, wherein the hydrocarbon-based ester is a branched and saturated monoester.

16. The composition according to claim 1, wherein the hydrocarbon-based ester is a monoester of a linear monounsaturated fatty acid and of a linear monounsaturated fatty alcohol.

17. The composition according to claim 1, wherein the hydrocarbon-based ester contains from 10 to 60 carbon atoms.

18. The composition according to claim 1, wherein the ester is selected from the group consisting of neopentanoic acid esters, isononanoic acid esters, isopropyl alcohol esters, cetyl octanoate, tridecyl octanoate, 2-ethylhexyl 4-diheptanoate and palmitate, alkyl benzoate, polyethylene glycol diheptanoate and propylene glycol diethyl 2-hexanoate, purcellin oil, isopropyl myristate, ethyl palmitate, octyl stearate, isostearyl lactate, octyl hydroxystearate, diisopropyl adipate, fatty alcohol heptanoates, octanoates and decanoates, and mixtures thereof.

19. The composition according to claim 1, wherein the hydrocarbon-based ester is selected from the group consisting of isononyl isononanoate, oleyl erucate and 2-octyldodecyl neopentanoate, and mixtures thereof.

20. The composition according to claim 1, wherein said composition is in the form of a lipstick, a lip gloss, a makeup rouge, an eyeshadow, a mascara, an eyeliner, a nail varnish, an artificial tanning product for the skin, a hair colouring product or a haircare product.

21. The composition according to claim 1, further comprising at least one dyestuff.

22. The composition according to claim 1, further comprising at least one polyethylene wax.

23. The composition according to claim 22, wherein the mean gloss of the composition is greater than or equal to 30.

24. The composition according to claim 1, further comprising at least one additional additive selected from the group consisting of water, antioxidants, preserving agents, neutralizers, lipophilic gelling agents or non-aqueous liquid compounds, aqueous phase-gelling agents, dispersants and cosmetic active agents, and mixtures thereof.

25. The composition according to claim 1, wherein said composition is in cast or compacted form.

26. The composition according to claim 1, wherein said composition in the form of an oily continuous phase.

27. The composition according to claim 1, wherein said composition is in anhydrous form.

28. The composition according to claim 1, wherein said composition is in the form of a lipstick or a lip gloss.

29. A process for giving a film of cosmetic composition tack-resistance, migration-resistance, gloss and/or comfort properties, comprising introducing into the composition i) at least one polyester resulting from the esterification, with a polycarboxylic acid, of an aliphatic hydroxycarboxylic acid ester, the ester comprising at least two hydroxyl groups and ii) at least one hydrocarbon-based ester other than the polyester.

30. A method, comprising applying the composition of claim 1 to the human body, lips or integuments.
